(19) United States
(12) Patent Application Publication
(10) Pub. No.: US 2026/0085177 A1
(43) Pub. Date: Mar. 26, 2026

(54) POLYPROPYLENE COMPOSITION FOR CABLE INSULATION

(71) Applicant: BOREALIS AG, Vienna (AT)

(72) Inventors: Katja Klimke, Linz (AT); Per-Ola Hagstrand, Stenungsund (SE); Ulf Nilsson, Stenungsund (SE); Thomas Gkourmpis, Stenungsund (SE); Lars Efraimsson, Stenungsund (SE); Anette Johansson, Stenungsund (SE); Kristian Dahlén, Stenungsund (SE); Jingbo Wang, Linz (AT); Gerhard Hubner, Linz (AT)

(21) Appl. No.: 19/114,033

(22) PCT Filed: Sep. 26, 2023
(86) PCT No.: PCT/EP2023/076453

§ 371 Date: Mar. 21, 2025

(30) Foreign Application Priority Data
Sep. 28, 2022 (EP) 22 198 362.0

(51) Int. Cl. C08L 23/14; H01B 3/44; H01B 9/00

(52) U.S. Cl. CPC C08L 23/142; H01B 3/441; C08L 2203/202; C08L 2205/025; C08L 2205/24; C08L 2207/02; C08L 2207/062; C08L 2207/066; H01B 9/00

(57) ABSTRACT

The present invention relates to a polypropylene composition comprising (A) from 80.0 to 99.0 wt.-% of a copolymer of propylene and comonomer units selected from ethylene and alpha-olefins having from 4 to 12 carbon atoms having a total amount of comonomer units of from 10.0 to 16.0 wt %, based on the total amount of monomer units of the copolymer of propylene (A); a melt flow rate MFR2 of from 0.5 to 2.5 g/10 min; a xylene cold soluble (XCS) fraction in a total amount of from 25.0 to 50.0 wt %, based on the total weight amount of the copolymer of propylene (A); and (B) from 1.0 to 20.0 wt.-% of an ethylene polymer having a density of from 915 to 960 kg/m³; and a melt flow rate MFR₅ (190° C., 5 kg) of from 0.05 to 5.0 g/10 min, an article comprising said polypropylene composition, preferably a cable comprising an insulation layer comprising said polypropylene composition, and the use of said polypropylene composition as cable insulation for medium and high voltage cables.

The present invention relates to a flexible polypropylene composition, an article comprising said polypropylene composition, preferably a cable comprising an insulation layer comprising said polypropylene composition and the use of said polypropylene composition as cable insulation for medium and high voltage cables.

### TECHNICAL BACKGROUND

Nowadays, ethylene polymer products are used as insulation and semiconducting shields for low, medium and high voltage cables, due to easy processability and their beneficial electrical properties. In addition, in low voltage applications polyvinyl chloride (PVC) is also commonly used as insulation material, usually in combination with softeners to reach desirable softness of cables. PVC is a thermoplastic which by incorporation of various plasticizers can be used in a wide temperature range. For standard PVC a continuous conductor temperature of max. 70° C. is normal. At low temperatures PVC becomes rigid and usage temperatures below −10° C. should be avoided. At conductor temperatures over 100° C. the plasticizers migrate out and the materials lose their flexibility. However, with the addition of special plasticizers and stabilizers, PVC materials can be produced for conductor temperatures of 90-105° C. But in essence, PVC is mainly used for the 1 kV area, as the higher permittivity and dissipation factor of the material means that the losses increase too much at higher voltages and therefore PVC cables are not normally not used over 1 kV. In addition, softeners have to be added to PVC in order to maintain a high level of flexibility. Insufficient amounts of softeners reduce low temperature properties of PVC significantly. From an environmental point of view, these softeners are not always regarded as problem-free, making them desirable to eliminate.

Especially for medium, high and extra high voltage (MV, HV and EHV) cables, as well as high-voltage direct current (HVDC) cables, insulation material presently is dominated by crosslinked ethylene polymer (XLPE) products. These products have a high operation temperature, a high electric breakdown strength and good mechanical properties. However, due to its crosslinking the XLPE is not recyclable by remelting. Therefore, attempts were made to use thermoplastic material and especially thermoplastic propylene polymers as insulation material for medium, high and extra high voltage (MV, HV and EHV) cables as well as high-voltage direct current (HVDC) cables. Further, power network owners are developing an increasing interest for cables that can be recycled by remelting.

Thus, there is an increasing interest in polymer compositions based on thermoplastic propylene polymers for insulation layers of medium voltage (MV), high voltage (HV), extra high voltage (EHV) and high-voltage direct current (HVDC) cables. Thereby, the propylene polymers need to show a good balance of properties as regards flexibility, mechanical properties, impact properties and electrical breakdown strength.

Thus, there is a need in the art for polypropylene compositions suitable for cable insulation and shows a good balance of properties as regards flexibility, mechanical properties, impact properties and electric breakdown strength, when used as cable insulation for MV or HV cables.

### SUMMARY OF THE INVENTION

In one aspect the present invention relates to a polypropylene composition comprising
(A) from 80.0 to 99.0 wt.-%, preferably from 82.5 to 97.2 wt. %, most preferably from 85.0 to 95.0 wt.-%, based on the total weight of the polypropylene composition, of a copolymer of propylene and comonomer units selected from ethylene and alpha-olefins having from 4 to 12 carbon atoms having
   a total amount of comonomer units of from 10.0 to 16.0 wt %, preferably from 11.0 to 15.0 wt %, most preferably from 12.0 to 14.0 wt %, based on the total amount of monomer units of the copolymer of propylene (A);
   a melt flow rate MFR₂ of from 0.5 to 2.5 g/10 min, preferably from 0.8 to 2.3 g/10 min, still more preferably from 1.0 to 2.0 g/10 min and most preferably from 1.2 to 1.7 g/10 min;
   a xylene cold soluble (XCS) fraction in a total amount of from 25.0 to 50.0 wt %, preferably from 27.5 to 45.0 wt %, more preferably from 30.0 to 42.5 wt % and most preferably from 32.5 to 40.0 wt %, based on the total weight amount of the copolymer of propylene (A); and
(B) from 1.0 to 20.0 wt.-%, preferably from 2.5 to 17.5 wt %, most preferably from 5.0 to 15.0 wt.-%, based on the total weight of the polypropylene composition, of an ethylene polymer having
   a density of from 915 to 960 kg/m³, preferably from 917 to 957 kg/m³, most preferably from 920 to 955 kg/m³; and
   a melt flow rate MFR₅ (190° C., 5 kg) of from 0.05 to 5.0 g/10 min, preferably from 0.10 to 4.0 g/10 min, most preferably from 0.15 to 3.5 g/10 min.

In another aspect the present invention relates to an article comprising the polypropylene composition as described above or below.

Preferably said article is a cable comprising an insulation layer comprising the polypropylene composition as described above or below.

In yet another aspect the present invention relates to the use of the polypropylene composition as described above or below as cable insulation for medium and high voltage cables.

### Definitions

A heterophasic polypropylene is a propylene-based copolymer with a semi-crystalline matrix phase, which can be a propylene homopolymer or a random copolymer of propylene and at least one alpha-olefin comonomer, and an elastomeric phase dispersed therein. The elastomeric phase can be a propylene copolymer with a high amount of comonomer, which is not randomly distributed in the polymer chain but are distributed in a comonomer-rich block structure and a propylene-rich block structure.

A heterophasic polypropylene usually differentiates from a one-phasic propylene copolymer in that it shows two distinct glass transition temperatures Tg which are attributed to the matrix phase and the elastomeric phase.

A propylene homopolymer is a polymer, which essentially consists of propylene monomer units. Due to impurities especially during commercial polymerization processes a propylene homopolymer can comprise up to 0.1 mol % comonomer units, preferably up to 0.05 mol % comonomer units and most preferably up to 0.01 mol % comonomer units.

A propylene random copolymer is a copolymer of propylene monomer units and comonomer units in which the comonomer units are distributed randomly over the polypropylene chain. Thereby, a propylene random copolymer includes a fraction, which is insoluble in xylene-xylene cold insoluble (XCI) fraction—in an amount of at least 85 wt %, most preferably of at least 88 wt %, based on the total amount of propylene random copolymer. Accordingly, the propylene random copolymer does not contain an elastomeric polymer phase dispersed therein.

Usually, a propylene polymer comprising at least two propylene polymer fractions (components), which have been produced under different polymerization conditions resulting in different (weight average) molecular weights and/or different comonomer contents for the fractions, preferably produced by polymerizing in multiple polymerization stages with different polymerization conditions, is referred to as “multimodal”. The prefix “multi” relates to the number of different polymer fractions the propylene polymer is consisting of. As an example of multimodal propylene polymer, a propylene polymer consisting of two fractions only is called “bimodal”, whereas a propylene polymer consisting of three fractions only is called “trimodal”.

A unimodal propylene polymer only consists of one fraction.

Thereby, the term “different” means that the propylene polymer fractions differ from each other in at least one property, preferably in the weight average molecular weight—which can also be measured in different melt flow rates of the fractions—or comonomer content or both.

An ethylene polymer is a polymer with a molar majority of ethylene monomer units. An ethylene homopolymer is a polymer, which essentially consists of ethylene monomer units. Due to impurities especially during commercial polymerization processes a ethylene homopolymer can comprise up to 0.1 mol % comonomer units, preferably up to 0.05 mol % comonomer units and most preferably up to 0.01 mol % comonomer units.

Ethylene homo- and copolymers polymerized in a low pressure process in the presence of a polymerization catalyst are classified in dependence of their density (which predominantly depends on the comonomer content). Said ethylene polymers typically show a low degree of branching, especially long chain branching. Short chain branches are introduced by higher alpha-olefin comononers (C3 to C12 alpha-olefin comonomers).

High density polyethylene (HDPE) has a density of from 940 to 980 kg/m³. Linear low density polyethylene (LLDPE) has a density of from 910 to below 940 kg/m³.

Very low density polymer (VLDPE) has a density of below 910 kg/m³. Depending on its properties VLDPE can also be classified as plastomer or elastomer.

Low density polyethylene (LDPE) is polymerized in a high pressure process by means of free radical polymerization (i.e. without polymerization catalyst). In contrast to ethylene homo- and copolymers polymerized in a low pressure process LDPE shows a higher degree of branching, especially long chain branching. Due to the high degree of branching LDPE has a density of from 915 to 930 kg/m³.

Vis-breaking is a post reactor chemical process for modifying semi-crystalline polymers such as propylene polymers. During the vis-breaking process, the propylene polymer backbone is degraded, for example by means of peroxides, such as organic peroxides, via beta scission. The degradation is generally used for increasing the melt flow rate and narrowing the molecular weight distribution.

In the following amounts are given in % by weight (wt %) unless it is stated otherwise.

### DETAILED DESCRIPTION OF THE INVENTION

### Polypropylene Composition

In one aspect the present invention relates to a polypropylene composition comprising
(A) from 80.0 to 99.0 wt.-%, preferably from 82.5 to 97.2 wt. %, most preferably from 85.0 to 95.0 wt.-%, based on the total weight of the polypropylene composition, of a copolymer of propylene and comonomer units selected from ethylene and alpha-olefins having from 4 to 12 carbon atoms having
   a total amount of comonomer units of from 10.0 to 16.0 wt %, preferably from 11.0 to 15.0 wt %, most preferably from 12.0 to 14.0 wt %, based on the total amount of monomer units of the copolymer of propylene (A);
   a melt flow rate MFR₂ of from 0.5 to 2.5 g/10 min, preferably from 0.8 to 2.3 g/10 min, still more preferably from 1.0 to 2.0 g/10 min and most preferably from 1.2 to 1.7 g/10 min;
   a xylene cold soluble (XCS) fraction in a total amount of from 25.0 to 50.0 wt %, preferably from 27.5 to 45.0 wt %, more preferably from 30.0 to 42.5 wt % and most preferably from 32.5 to 40.0 wt %, based on the total weight amount of the copolymer of propylene (A); and
(B) from 1.0 to 20.0 wt.-%, preferably from 2.5 to 17.5 wt %, most preferably from 5.0 to 15.0 wt.-%, based on the total weight of the polypropylene composition, of an ethylene polymer having
   a density of from 915 to 960 kg/m³, preferably from 917 to 957 kg/m³, most preferably from 920 to 955 kg/m³; and
   a melt flow rate MFR₅ (190° C., 5 kg) of from 0.05 to 5.0 g/10 min, preferably from 0.10 to 4.0 g/10 min, most preferably from 0.15 to 3.5 g/10 min.

The polypropylene composition preferably comprises the copolymer of propylene and comonomer units selected from ethylene and alpha-olefins having from 4 to 12 carbon atoms (A) in an amount of from 80.0 to 99.0 wt.-%, preferably from 82.5 to 97.2 wt. %, most preferably from 85.0 to 95.0 wt.-% and the ethylene polymer (B) in an amount of from 1.0 to 20.0 wt.-%, preferably from 2.5 to 17.5 wt %, most preferably from 5.0 to 15.0 wt.-%, all based on the total weight of the polypropylene composition.

In the following the copolymer of propylene and comonomer units selected from ethylene and alpha-olefins having from 4 to 12 carbon atoms (A) is also denoted component (A) and the ethylene polymer (B) is also denoted component (B).

The polypropylene composition can further comprise polymeric components, which are different from the components (A) and (B), in an amount of preferably 0.0 to 10.0 wt % based on the total weight of the polypropylene composition.

In a preferred embodiment the polymeric components of the polypropylene composition consist of components (A) and (B).

Besides these polymeric components the polypropylene composition can comprise one or more additives in an amount of from 0.0 up to 5.0 wt %, based on the total weight of the polypropylene composition. The one or more additives are preferably selected from acid scavengers, antioxidants, alpha nucleating agents, beta nucleating agents, etc. Such additives are commercially available and for example described in “Plastic Additives Handbook”, 6^{th} edition 2009 of Hans Zweifel (pages 1141 to 1190).

Usually, these additives are added in quantities of 1 to 50000 ppm for each single component.

In one embodiment the polypropylene composition comprises an alpha-nucleating agent. The alpha nucleating agent is preferably present in an amount of from 500 to 5000 ppm, preferably from 750 to 4000 ppm, most preferably from 1000 to 3000 ppm, based on the total weight of the polypropylene composition.

The alpha-nucleating agent (B) is preferably selected from soluble alpha-nucleating agents and particulate alpha-nucleating agents.

The alpha-nucleating agent (B) is preferably selected from the group consisting of
(i) salts of monocarboxylic acids and polycarboxylic acids, e.g. sodium benzoate or aluminum tert-butylbenzoate, and
(ii) dibenzylidenesorbitol (e.g. 1,3:2,4 dibenzylidenesorbitol) and C₁-C₈-alkyl-substituted dibenzylidenesorbitol derivatives, such as methyldibenzylidenesorbitol, ethyldibenzylidenesorbitol or dimethyldibenzylidenesorbitol (e.g. 1,3:2,4 di(methylbenzylidene) sorbitol), or substituted nonitol-derivatives, such as 1,2,3-trideoxy-4,6:5,7-bis-O-[(4-propylphenyl)methylene]-nonitol, and
(iii) salts of diesters of phosphoric acid, e.g. sodium 2,2′-methylenebis (4,6-di-tertbutylphenyl) phosphate or aluminium-hydroxy-bis[2,2′-methylene-bis(4,6-di-tbutylphenyl)phosphate], and
(iv) vinylcycloalkane polymer and vinylalkane polymer (as discussed in more detail below), and
(v) mixtures thereof.

The alpha-nucleating agent is preferably selected from the group consisting of dibenzylidenesorbitol (e.g. 1,3:2,4 dibenzylidene sorbitol), dibenzylidenesorbitol derivative, preferably dimethyldibenzylidenesorbitol (e.g. 1,3:2,4 di(methylbenzylidene) sorbitol), or substituted nonitol-derivatives, such as 1,2,3-trideoxy-4,6:5,7-bis-O-[(4-propylphenyl)methylene]-nonitol, vinylcycloalkane polymer, vinylalkane polymer, and mixtures thereof.

In another embodiment the polypropylene composition preferably comprises an acid scavenger, such as calcium stearate. The acid scavenger is preferably present in an amount of from 1000 to 7500 ppm, preferably from 1500 to 6000 ppm, most preferably from 2000 to 5000 ppm, based on the total weight of the polypropylene composition.

The one or more additives can be added to the polymeric components in a blending step.

Thereby, the one or more additives can be added to the polymeric components in form of master batches in which one or more additives are blended with a carrier polymer in concentrated amounts. Any optional carrier polymer is calculated to the amount of additives, based on the total weight of the propylene copolymer composition.

The polypropylene composition preferably has a total amount of units derived from ethylene of from 15.0 to 30.0 wt %, more preferably from 17.5 to 27.5 wt % and most preferably from 19.0 to 25.0 wt %, based on the total amount of monomer units in the polypropylene composition.

Further, the polypropylene composition preferably has a total amount of units derived from propylene of from 80.0 to 95.0 wt %, more preferably from 82.5 to 92.5 wt % and most preferably from 85.0 to 90.0 wt %, based on the total amount of monomer units in the polypropylene composition.

Still further, the polypropylene composition preferably has a total amount of units derived from alpha-olefins having from 4 to 12 carbon atoms of from 0 to 2.5 wt %, more preferably from 0 to 2.0 wt %, most preferably from 0 to 1.5 wt %, based on the total amount of monomer units in the polypropylene composition.

The alpha-olefins having from 4 to 12 carbon atoms are preferably selected from 1-butene, 1-hexene or 1-octene. The alpha-olefins having from 4 to 12 carbon atoms can be one type of comonomer units or two or more types such as two types of comonomer units. It is preferred that the alpha-olefins having from 4 to 12 carbon atoms are one type of comonomer units. Especially preferred is 1-butene or 1-hexene.

It is preferred that the polymeric compounds of the polypropylene composition consist of units derived from propylene, ethylene and optionally alpha-olefins having from 4 to 12 carbon atoms. Thus, the weight amounts of units derived from propylene, ethylene and optionally alpha-olefins having from 4 to 12 carbon atoms, add up to 100 wt % of the total amount of monomer units in the polypropylene composition.

The polypropylene composition preferably has a xylene cold soluble (XCS) fraction in a total amount of from 20.0 to 45.0 wt %, more preferably from 22.5 to 42.5 wt %, still more preferably from 25.0 to 40.0 wt % and most preferably from 27.5 to 37.5 wt %, based on the total weight amount of the polypropylene composition.

The xylene cold soluble (XCS) fraction preferably has a total amount of units derived from ethylene of from 15.0 to 35.0 wt %, more preferably from 17.5 to 32.5 wt % and most preferably from 20.0 to 30.0 wt %, based on the total amount of monomer units in the xylene cold soluble (XCS) fraction.

Further, the xylene cold soluble (XCS) fraction preferably has a total amount of units derived from propylene of from 65.0 to 85.0 wt %, more preferably from 67.5 to 82.5 wt % and most preferably from 70.0 to 80.0 wt %, based on the total amount of monomer units in the xylene cold soluble (XCS) fraction.

Still further, the xylene cold soluble (XCS) fraction preferably has a total amount of units derived from alpha-olefins having from 4 to 12 carbon atoms of from 0 to 5.0 wt %, more preferably from 0 to 4.0 wt %, most preferably from 0 to 2.5 wt %, based on the total amount of monomer units in the xylene cold soluble (XCS) fraction.

It is preferred that the polymeric compounds of the xylene cold soluble (XCS) fraction consist of units derived from propylene, ethylene and optionally alpha-olefins having from 4 to 12 carbon atoms. Thus, the weight amounts of units derived from propylene, ethylene and optionally alpha-olefins having from 4 to 12 carbon atoms add up to 100 wt % of the total amount of monomer units in the xylene cold soluble (XCS) fraction.

Further, the xylene cold soluble (XCS) fraction preferably has an intrinsic viscosity of from 175 to 325 cm³/g, preferably from 200 to 300 cm³/g and most preferably from 225 to 275 cm³/g, measured in decalin.

Additionally, the xylene cold soluble (XCS) fraction preferably has a weight average molecular weight Mw of from 200000 to 350000 g/mol, more preferably from 225000 to 325000 g/mol and most preferably from 250000 to 300000 g/mol.

Furthermore, the xylene cold soluble (XCS) fraction preferably has a polydispersity index, being the ratio of the weight average molecular weight and the number average molecular weight Mw/Mn, of from 5.0 to 9.0, preferably from 5.5 to 8.5 and most preferably from 6.0 to 8.0.

Further, the polypropylene composition has a fraction insoluble in cold xylene (XCI) preferably in a total amount of from 55.0 to 80.0 wt %, more preferably from 57.5 to 77.5 wt % still more preferably from 60.0 to 75.0 wt % and most preferably from 62.5 to 72.5 wt %, based on the total weight amount of the polypropylene composition.

In the polypropylene composition the xylene cold soluble (XCS) fraction and the fraction insoluble in cold xylene (XCI) add to 100 wt % of the polypropylene composition.

The fraction insoluble in cold xylene (XCI) preferably has a total amount of units derived from ethylene of from 7.5 to 25.0 wt %, more preferably from 10.0 to 22.5 wt % and most preferably from 12.5 to 20.0 wt %, based on the total amount of monomer units in the fraction insoluble in cold xylene (XCI).

Further, the fraction insoluble in cold xylene (XCI) preferably has a total amount of units derived from propylene of from 75.0 to 92.5 wt %, more preferably from 77.5 to 90.0 wt % and most preferably from 80.0 to 87.5 wt %, based on the total amount of monomer units in the fraction insoluble in cold xylene (XCI).

Still further, the fraction insoluble in cold xylene (XCI) preferably has a total amount of units derived from alpha-olefins having from 4 to 12 carbon atoms of from 0 to 2.0 wt %, more preferably from 0 to 1.5 wt %, most preferably from 0 to 1.0 wt %, based on the total amount of monomer units in the fraction insoluble in cold xylene (XCI).

It is preferred that the polymeric compounds of the fraction insoluble in cold xylene (XCI) consist of units derived from propylene, ethylene and optionally alpha-olefins having from 4 to 12 carbon atoms. Thus, the weight amounts of units derived from propylene, ethylene and optionally alpha-olefins having from 4 to 12 carbon atoms add up to 100 wt % of the total amount of monomer units in the fraction insoluble in cold xylene (XCI).

Further, the fraction insoluble in cold xylene (XCI) preferably has an intrinsic viscosity of from 200 to 350 cm³/g, preferably from 225 to 325 cm³/g and most preferably from 240 to 300 cm³/g, measured in decalin.

Additionally, the fraction insoluble in cold xylene (XCI) preferably has a weight average molecular weight Mw of from 250000 to 450000 g/mol, more preferably from 275000 to 425000 g/mol and most preferably from 300000 to 400000 g/mol.

Furthermore, the fraction insoluble in cold xylene (XCI) preferably has a polydispersity index, being the ratio of the weight average molecular weight and the number average molecular weight Mw/Mn, of from 5.0 to 9.0, preferably from 5.5 to 8.7 and most preferably from 6.0 to 8.5.

The ratio of the intrinsic viscosities of the XCI fraction to the XCS fraction of the polypropylene composition (IV(XCI)/IV(XCS)) is preferably in the range of from 0.8 to 1.5, more preferably from 0.9 to 1.4 and most preferably from 1.0 to 1.3.

Further, the ratio of the weight average molecular weights of the XCI fraction to the XCS fraction of the polypropylene composition (Mw(XCI)/Mw(XCS)) is preferably in the range of from 1.00 to 1.50, more preferably from 1.05 to 1.40 and most preferably from 1.10 to 1.35.

The polypropylene composition preferably has a melt flow rate MFR₂ of 0.5 to 2.5 g/10 min, preferably from 0.7 to 2.2 g/10 min, still more preferably from 0.9 to 2.0 g/10 min and most preferably from 1.0 to 1.7 g/10 min.

The polypropylene composition preferably has a flexural modulus of from 175 MPa to 425 MPa, more preferably of from 200 MPa to 400 MPa and most preferably of from 225 MPa to 385 MPa.

Preferably, the polypropylene composition has a Charpy notched impact strength at 23° C. of from 50 to 110 kJ/m², more preferably from 65 to 100 kJ/m² and most preferably from 70 to 95 kJ/m².

Further, the polypropylene composition preferably has a Charpy notched impact strength at −20° C. of from 4.5 to 25.0 kJ/m², more preferably from 5.0 to 20.0 kJ/m² and most preferably from 5.5 to 15.0 kJ/m².

Further, the polypropylene composition has a melting temperature Tm of from 120 to 159° C., preferably from 123 to 157° C. and most preferably from 125 to 153° C.

Additionally, the polypropylene composition preferably has a crystallization temperature Tc of from 90 to 130° C., more preferably from 92 to 128° C. and most preferably from 95 to 125° C.

The difference of the melting temperature to the crystallization temperature Tm-Tc is preferably in the range of from 2 to 65° C., preferably 5 to 60° C. and most preferably from 7 to 55° C.

The polypropylene composition preferably has at least two glass transition temperatures. Said two glass transition temperatures can be attributed to the matrix phase (Tg (matrix)) and the elastomeric phase (Tg (EP)).

Further. the polypropylene composition preferably has a glass temperature attributed to the matrix phase Tg (matrix) in the range of from −1.0 to −17.5° C., preferably from −2.5 to −15.0° C. and most preferably from −5.0 to −12.5° C.

Still further, the polypropylene composition preferably has a glass temperature attributed to the elastomeric phase Tg (EP) of from −40.0 to −55.0° C., preferably from −42.5 to −52.5° C. and most preferably from −45.0 to −50.0° C.

Preferably, the polypropylene composition has a shear thinning index SHI_{1/100} of from 5.0 to 20.0, more preferably from 7.5 to 17.5 and most preferably from 8.5 to 15.0.

Further, the polypropylene composition preferably has a polydispersity index PI of from 1.0 to 4.5 s⁻¹, more preferably from 1.5 to 4.0 s⁻¹ and most preferably from 2.0 to 3.5 s⁻¹.

Preferably, the polypropylene composition is prepared by melt blending the components (A) and (B), the optional additional polymeric components and the optional further additives, all as described above or below.

The polypropylene composition is preferably not subjected to vis-breaking.

It is preferred that the polypropylene composition does not comprise, i.e. is free of a dielectric fluid, such as e.g. described in EP 2 739 679.

In the following, the copolymer of propylene and comonomer units selected from ethylene and alpha-olefins having from 4 to 12 carbon atoms (A) (abbreviated “copolymer of propylene (A)” or component (A)) and the ethylene polymer (B) (also abbreviated or component (B)) described in more detail.

### Copolymer of Propylene (A)

The polypropylene composition according to the invention comprises a copolymer of propylene and comonomer units selected from ethylene and alpha-olefins having from 4 to 12 carbon atoms (A) (in the following “copolymer of propylene (A)”). The comonomer units are selected from ethylene and alpha-olefins having from 4 to 12 carbon atoms, such as ethylene, 1-butene, 1-hexene or 1-octene. The copolymer of propylene (A) can comprise one type of comonomer units or two or more types such as two types of comonomer units. It is preferred that the copolymer of propylene (A) comprises one type of comonomer units. Especially preferred is ethylene.

The copolymer of propylene (A) preferably has a total amount of comonomer units, preferably of ethylene, of from 10.0 to 16.0 wt %, preferably from 11.0 to 15.0 wt %, most preferably from 12.0 to 14.0 wt %, based on the total amount of monomer units in the copolymer of propylene (A).

It is preferred that the copolymer of propylene (A) is a heterophasic copolymer of propylene.

The heterophasic propylene copolymer has a matrix phase and an elastomeric phase dispersed in said matrix phase.

The matrix phase is preferably a propylene random copolymer.

The comonomer units of said propylene random copolymer of the matrix phase usually are the same as for the copolymer of propylene as described above. Said comonomer units preferably are selected from ethylene and alpha-olefins having from 4 to 12 carbon atoms, such as ethylene, 1-butene, 1-hexene or 1-octene. The propylene random copolymer of the matrix phase can comprise one type of comonomer units or two or more types such as two types of comonomer units. It is preferred that the propylene random copolymer of the matrix phase comprises one type of comonomer units. Especially preferred is ethylene.

Heterophasic propylene copolymers are typically characterized by comprising at least two glass transition temperatures. Said two glass transition temperatures can be attributed to the matrix phase (Tg (matrix)) and the elastomeric phase (Tg (EP)). The heterophasic propylene copolymer preferably has a glass transition temperature attributed to the matrix phase Tg (matrix) in the range of from −1.0 to −15.0° C., preferably from −2.5 to −12.5° C. and most preferably from −5.0 to −10.0° C.

Further, the heterophasic propylene copolymer preferably has a glass transition temperature attributed to the elastomeric phase Tg (EP) in the range of from −40.0 to −55.0° C., preferably from −42.5 to −52.5° C. and most preferably from −45.0 to −50.0° C.

In a copolymer of propylene (A), such as a heterophasic propylene copolymer, the matrix phase and the elastomeric phase usually cannot exactly be divided from each other. In order to characterize the matrix phase and the elastomeric phase of a heterophasic polypropylene copolymer several methods are known. One method is the extraction of a fraction, which contains to the most part the elastomeric phase with xylene, thus separating a xylene cold solubles (XCS) fraction from a xylene cold insoluble (XCI) fraction. The XCS fraction contains for the most part the elastomeric phase and only a small part of the matrix phase whereas the XCI fraction contains for the most part the matrix phase and only a small part of the elastomeric phase.

The copolymer of propylene (A) preferably has a xylene cold soluble (XCS) fraction in a total amount of from 25.0 to 50.0 wt %, more preferably from 27.5 to 45.0 wt %, still more preferably from 30.0 to 42.5 wt % and most preferably from 32.5 to 40.0 wt %, based on the total weight amount of the copolymer of propylene (A).

The xylene cold soluble (XCS) fraction preferably has an amount of comonomer units, preferably of ethylene, of from 23.0 to 35.0 wt %, more preferably from 23.5 to 32.5 wt % and most preferably from 24.0 wt % to 30.0 wt %, based on the total amount of monomer units in the xylene cold soluble (XCS) fraction.

Further, the xylene cold soluble (XCS) fraction preferably has an intrinsic viscosity of from 150 to 350 cm³/g, preferably from 200 to 325 cm³/g and most preferably from 225 to 300 cm³/g, measured in decalin.

Additionally, the xylene cold soluble (XCS) fraction preferably has a weight average molecular weight Mw of from 185000 to 350000 g/mol, more preferably from 200000 to 325000 g/mol and most preferably from 210000 to 315000 g/mol.

Furthermore, the xylene cold soluble (XCS) fraction preferably has a polydispersity index, being the ratio of the weight average molecular weight and the number average molecular weight Mw/Mn, of from 3.5 to 8.5, preferably from 3.7 to 8.0 and most preferably from 4.0 to 7.5.

Further, the copolymer of propylene (A) has a fraction insoluble in cold xylene (XCI) preferably in a total amount of from 50.0 to 75.0 wt %, more preferably from 55.0 to 72.5 wt %, still more preferably from 57.5 to 70.0 wt % and most preferably from 60.0 to 67.5 wt %, based on the total weight amount of the copolymer of propylene (A).

The fraction insoluble in cold xylene (XCI) preferably has an amount of comonomer units, preferably of ethylene, of from 3.0 to 9.0 wt %, preferably from 4.0 to 8.5 wt % and most preferably from 4.5 to 7.5 wt %, based on the total amount of monomer units in the fraction insoluble in cold xylene (XCI).

Further, the fraction insoluble in cold xylene (XCI) preferably has an intrinsic viscosity of from 185 to 350 cm³/g, preferably from 220 to 325 cm³/g and most preferably from 210 to 300 cm³/g, measured in decalin.

Additionally, the fraction insoluble in cold xylene (XCI) preferably has a weight average molecular weight Mw of from 225000 to 450000 g/mol, more preferably from 240000 to 425000 g/mol and most preferably from 260000 to 400000 g/mol.

Furthermore, the fraction insoluble in cold xylene (XCI) preferably has a polydispersity index, being the ratio of the weight average molecular weight and the number average molecular weight Mw/Mn, of from 3.5 to 7.5, preferably from 3.7 to 7.0 and most preferably from 4.0 to 6.5.

The ratio of the intrinsic viscosities of the XCI fraction to the XCS fraction of the copolymer of propylene is preferably in the range of from 0.9 to 1.5, more preferably from 1.0 to 1.4 and most preferably from 1.0 to 1.3.

The copolymer of propylene (A) preferably has a melt flow rate MFR₂ of 0.5 to 2.5 g/10 min, preferably from 0.8 to 2.3 g/10 min, still more preferably from 1.0 to 2.0 g/10 min and most preferably from 1.2 to 1.7 g/10 min.

The copolymer of propylene (A) preferably has a flexural modulus of from 130 MPa to 400 MPa, more preferably of from 150 MPa to 390 MPa and most preferably of from 175 MPa to 380 MPa.

Preferably, the copolymer of propylene (A) has a Charpy notched impact strength at 23° C. of from 50 to 110 kJ/m², more preferably from 65 to 100 kJ/m² and most preferably from 75 to 95 kJ/m².

Further, the copolymer of propylene (A) preferably has a Charpy notched impact strength at −20° C. of from 5.0 to 10.0 kJ/m², more preferably from 5.5 to 9.0 kJ/m² and most preferably from 6.0 to 8.0 kJ/m².

Further, the copolymer of propylene (A) has a melting temperature Tm of from 140 to 159° C., preferably from 143 to 157° C. and most preferably from 145 to 153° C.

Additionally, the copolymer of propylene (A) has a crystallization temperature Tc of from 85 to 130° C., preferably from 87 to 128° C. and most preferably from 90 to 125° C.

The difference of the melting temperature to the crystallization temperature Tm-Tc is preferably in the range of from 20 to 65° C., preferably 25 to 60° C. and most preferably from 27 to 55° C.

It is preferred that the copolymer of propylene (A) has an intrinsic viscosity of from 185 to 350 cm³/g, preferably from 200 to 325 cm³/g and most preferably from 210 to 300 cm³/g, measured in decalin.

The copolymer of propylene (A) can be polymerized in a sequential multistage polymerization process, i.e. in a polymerization process in which two or more polymerization reactors are connected in series. Preferably, in the sequential multistage polymerization process, two or more, more preferably three or more, such as three or four, polymerization reactors are connected in series. The term “polymerization reactor” shall indicate that the main polymerization takes place. Thus in case the process consists of four polymerization reactors, this definition does not exclude the option that the overall process comprises for instance a pre-polymerization step in a pre-polymerization reactor.

When the copolymer of propylene (A) is a heterophasic propylene copolymer, the matrix phase of the heterophasic propylene copolymer is polymerized in first polymerization reactor for producing a unimodal matrix phase or in the first and second polymerization reactor for producing a multimodal matrix phase. The elastomeric phase of the heterophasic propylene copolymer is preferably polymerized in the subsequent one or two polymerization reactor(s) in the presence of the matrix phase for producing a unimodal elastomeric phase or a multimodal elastomeric phase.

Preferably, the polymerization reactors are selected from slurry phase reactors, such as loop reactors and/or gas phase reactors such as fluidized bed reactors, more preferably from loop reactors and fluidized bed reactors.

A preferred sequential multistage polymerization process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315.

A further suitable slurry-gas phase process is the Spheripol® process of LyondellBasell.

Suitable sequential polymerization processes for polymerizing the copolymer of propylene (A), preferably the heterophasic propylene copolymer, are e.g. disclosed in EP 1681 315 A1 or WO 2013/092620 A1.

The copolymer of propylene (A), preferably the heterophasic propylene copolymer can be polymerized in the presence of a Ziegler-Natta catalyst or a single site catalyst.

Suitable Ziegler-Natta catalysts are e.g. disclosed in U.S. Pat. No. 5,234,879, WO 92/19653, WO 92/19658, WO 99/33843, WO 03/000754, WO 03/000757, WO 2013/092620 A1 or WO 2015/091839.

Suitable single site catalysts are e.g. disclosed in WO 2006/097497, WO 2011/076780 or WO 2013/007650.

The copolymer of propylene (A) is preferably not subjected to a visbreaking step as e.g. described in WO 2013/092620 A1.

Heterophasic propylene copolymer resins suitable as copolymer of propylene (A) are also commercially available. These resins are usually already additivated with stabilizer packages. Thus, when using commercially available resins as copolymer of propylene the addition of additives as described above might have to be adjusted to the already present additives.

### Polymer of Ethylene (B)

The polypropylene composition according to the invention comprises a polymer of ethylene (B).

The polymer of ethylene (B) can be an ethylene homopolymer or an ethylene copolymer.

The ethylene copolymer preferably is a copolymer of ethylene with comonomer units selected from alpha-olefins having from 4 to 12 carbon atoms.

The comonomer units are selected from alpha-olefins having from 4 to 12 carbon atoms, such as 1-butene, 1-hexene or 1-octene. The copolymer of ethylene can comprise one type of comonomer units or two or more types such as two types of comonomer units. It is preferred that the copolymer of ethylene (B) comprises one type of comonomer units. Especially preferred is 1-butene or 1-hexene.

The polymer of ethylene (B) has a density of from 915 to 960 kg/m³, preferably from 917 to 957 kg/m³, most preferably from 920 to 955 kg/m³.

Further, the polymer of ethylene (B) has a melt flow rate MFR₅ (190° C., 5 kg) of from 0.05 to 5.0 g/10 min, preferably from 0.10 to 4.0 g/10 min, most preferably from 0.15 to 3.5 g/10 min.

Still further, the polymer of ethylene (B) preferably has a melt flow rate MFR₂ (190° C., 2.16 kg) of from 0.001 to 2.0 g/10 min, more preferably from 0.005 to 1.7 g/10 min, most preferably from 0.01 to 1.5 g/10 min.

Additionally, the polymer of ethylene (B) preferably has a melting temperature Tm of from 95 to 140° C., more preferably from 100 to 137° C., most preferably from 105 to 135° C.

The polymer of ethylene (B) can be produced in a low pressure polymerization process in the presence of a polymerization catalyst, such as a Ziegler-Natta catalyst or a metallocene catalyst, preferably a Ziegler-Natta catalyst.

The polymer of ethylene produced in a low pressure polymerization process is preferably a copolymer of ethylene and comonomer units selected from alpha-olefins having from 4 to 12 carbon atoms, more preferably a high density copolymer of ethylene and comonomer units selected from alpha-olefins having from 4 to 12 carbon atoms (HDPE) or a linear low density copolymer of ethylene and comonomer units selected from alpha-olefins having from 4 to 12 carbon atoms (LLDPE).

The polymer of ethylene (B) can be produced in a high pressure polymerization process by means of free radical polymerization.

The polymer of ethylene produced in a high pressure polymerization process is preferably a low density polyethylene (LDPE), more preferably a low density polyethylene (LDPE) homopolymer.

Ethylene copolymer resins suitable as copolymer of ethylene (B) are also commercially available. These resins are usually already additivated with stabilizer packages. Thus, when using commercially available resins as copolymer of ethylene (B) the addition of additives as described above might have to be adjusted to the already present additives.

In one embodiment the copolymer of ethylene (B) is a high density copolymer of ethylene and comonomer units selected from alpha-olefins having from 4 to 12 carbon atoms (HDPE).

The HDPE preferably is a copolymer of ethylene with comonomer units selected from alpha-olefins having from 4 to 12 carbon atoms.

The comonomer units are selected from alpha-olefins having from 4 to 12 carbon atoms, such as 1-butene, 1-hexene or 1-octene. The copolymer of ethylene can comprise one type of comonomer units or two or more types such as two types of comonomer units. It is preferred that the copolymer of ethylene (B) comprises one type of comonomer units. Especially preferred is 1-butene or 1-hexene, mostly preferred is 1-hexene.

The HDPE can be a copolymer of ethylene and 1-butene or a copolymer of ethylene and 1-hexene, preferably a copolymer of ethylene and 1-hexene.

The HDPE preferably has a density of from 940 to 960 kg/m³, more preferably from 942 to 957 kg/m³, most preferably from 945 to 955 kg/m³.

Further, the HDPE preferably has a melt flow rate MFR₅ (190° C., 5 kg) of from 0.05 to 1.0 g/10 min, more preferably from 0.10 to 0.70 g/10 min, most preferably from 0.15 to 0.50 g/10 min.

Still further, the HDPE preferably has a melt flow rate MFR₂ (190° C., 2.16 kg) of from 0.001 to 0.5 g/10 min, more preferably from 0.005 to 0.3 g/10 min, most preferably from 0.01 to 0.1 g/10 min.

Further, the HDPE preferably has a melting temperature Tm of from 125 to 140° C., more preferably from 128 to 137° C., most preferably from 130 to 135° C.

Still further, the HDPE preferably has a crystallization temperature Tc of from 100 to 125° C., preferably from 105 to 122° C., most preferably from 110 to 120° C.

Additionally, the HDPE preferably has a tensile modulus of from 750 to 1250 MPa, more preferably from 800 to 1150 MPa, most preferably from 850 to 1100 MPa.

Further, the HDPE preferably has a tensile strain at break of from 400 to 850%, more preferably from 500 to 800%, most preferably from 550 to 750%.

Still further, the HDPE preferably has a tensile stress at yield of from 15 to 40 MPa, more preferably from 20 to 35 MPa, most preferably from 22 to 32 MPa.

The HDPE is preferably a multimodal, more preferably a bimodal copolymer of ethylene and alpha olefin comonomer units having from 4 to 12 carbon atoms. The term “multimodal” means herein, unless otherwise stated, multimodality with respect to molecular weight distribution and includes therefore a bimodal polymer. Usually, a polyethylene composition, comprising at least two polyethylene fractions, which have been produced under different polymerization conditions resulting in different (weight average) molecular weights and molecular weight distributions for the fractions, is referred to as “multimodal”. The prefix “multi” relates to the number of different polymer fractions present in the polymer. Thus, for example, multimodal polymer includes so called “bimodal” polymer consisting of two fractions. The form of the molecular weight distribution curve, i.e. the appearance of the graph of the polymer weight fraction as a function of its molecular weight, of a multimodal polymer will show two or more maxima or is typically distinctly broadened in comparison with the curves for the individual fractions. For example, if a polymer is produced in a sequential multistage process, utilizing reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions form typically together a broadened molecular weight distribution curve for the total resulting polymer product.

In a second embodiment the copolymer of ethylene (B) is a linear low density copolymer of ethylene and comonomer units selected from alpha-olefins having from 4 to 12 carbon atoms (LLDPE).

The LLDPE preferably is a copolymer of ethylene with comonomer units selected from alpha-olefins having from 4 to 12 carbon atoms.

The comonomer units are selected from alpha-olefins having from 4 to 12 carbon atoms, such as 1-butene, 1-hexene or 1-octene. The copolymer of ethylene can comprise one type of comonomer units or two or more types such as two types of comonomer units. It is preferred that the copolymer of ethylene (B) comprises one type of comonomer units. Especially preferred is 1-butene or 1-hexene, mostly preferred is 1-hexene.

The LLDPE can be a copolymer of ethylene and 1-butene or a copolymer of ethylene and 1-hexene, preferably a copolymer of ethylene and 1-butene.

The LLDPE preferably has a density of from 920 to below 940 kg/m³, preferably from 922 to 937 kg/m³, most preferably from 925 to 935 kg/m³.

Additionally, the LLDPE preferably has a comonomer content, preferably a 1-butene or 1-hexene content, most preferably a 1-butene content, of from 1.0 to 5.0 mol %, preferably from 1.5 to 4.0 mol %, most preferably from 2.0 to 3.0 mol %.

Further, the LLDPE preferably has a melt flow rate MFR₅ (190° C., 5 kg) of from 0.1 to 2.5 g/10 min, more preferably from 0.3 to 2.0 g/10 min, most preferably from 0.5 to 1.5 g/10 min.

Still further, the LLDPE preferably has a melt flow rate MFR₂ (190° C., 2.16 kg) of from 0.01 to 1.0 g/10 min, more preferably from 0.05 to 0.7 g/10 min, most preferably from 0.1 to 0.5 g/10 min.

Furthermore, the LLDPE preferably has a melt flow rate MFR₂₁ (190° C., 21.6 kg) of from 5 to 35 g/10 min, more preferably from 10 to 30 g/10 min, most preferably from 15 to 25 g/10 min.

Further, the LLDPE preferably has a flow rate ratio FRR_{21/5}, being the ratio of MFR₂₁ to MFR₅, of from 5 to 35, more preferably from 10 to 30, most preferably from 15 to 25.

Still further, the LLDPE preferably has a flow rate ratio FRR_{21/2}, being the ratio of MFR₂₁ to MFR₂, of from 85 to 115, more preferably from 90 to 110, most preferably from 95 to 105.

Further, the LLDPE preferably has a melting temperature Tm of from 120 to 135° C., more preferably from 123 to 132° C., most preferably from 125 to 130° C.

The LLDPE is preferably a multimodal, more preferably a bimodal copolymer of ethylene and alpha olefin comonomer units having from 4 to 12 carbon atoms.

For the preparation of the copolymer of ethylene and comonomer units selected from alpha-olefins having from 4 to 12 carbon atoms, such as the HDPE of the first embodiment or the LLDPE of the second embodiment, polymerisation methods well known to the skilled person may be used. It is within the scope of the invention for a multimodal, e.g. at least bimodal, polymers to be produced by blending each of the components in-situ during the polymerisation process thereof (so called in-situ process) or, alternatively, by blending mechanically two or more separately produced components in a manner known in the art.

Ethylene copolymers useful in the present invention as the copolymer of ethylene and comonomer units selected from alpha-olefins having from 4 to 12 carbon atoms, such as the HDPE of the first embodiment or the LLDPE of the second embodiment, are preferably obtained by in-situ blending in a multistage polymerisation process. Accordingly, copolymers are obtained by in-situ blending in a multistage, i.e. two or more stage, polymerization process including solution, slurry and gas phase process, in any order. Whilst it is possible to use different polymerization catalysts in each stage of the process, it is preferred if the catalyst employed is the same in both stages.

Ideally therefore, the copolymer of ethylene and comonomer units selected from alpha-olefins having from 4 to 12 carbon atoms, such as the HDPE of the first embodiment or the LLDPE of the second embodiment, used in the blend of the invention are produced in at least two-stage polymerization using a single site catalyst or Ziegler Natta catalyst, preferably a Ziegler Natta catalyst. Thus, for example two slurry reactors or two gas phase reactors, or any combinations thereof, in any order can be employed. Preferably however, the ethylene copolymer is made using a slurry polymerization in a loop reactor followed by a gas phase polymerization in a gas phase reactor.

A loop reactor—gas phase reactor system is well known as Borealis technology, i.e. as a BORSTAR™ reactor system. Such a multistage process is disclosed e.g. in EP517868.

The conditions used in such a process are well known. For slurry reactors, the reaction temperature will generally be in the range 60 to 110° C., e.g. 85 to 110° C., the reactor pressure will generally be in the range 5 to 80 bar, e.g. 50 to 65 bar, and the residence time will generally be in the range 0.3 to 5 hours, e.g. 0.5 to 2 hours. The diluent used will generally be an aliphatic hydrocarbon having a boiling point in the range −70 to +100° C., e.g. propane. In such reactors, polymerization may if desired be effected under supercritical conditions. Slurry polymerisation may also be carried out in bulk where the reaction medium is formed from the monomer being polymerised. For gas phase reactors, the reaction temperature used will generally be in the range 60 to 115° C., e.g. 70 to 110° C., the reactor pressure will generally be in the range 10 to 25 bar, and the residence time will generally be 1 to 8 hours. The gas used will commonly be a non-reactive gas such as nitrogen or low boiling point hydrocarbons such as propane together with monomer, e.g. ethylene. Preferably, the first polymer fraction is produced in a continuously operating loop reactor where ethylene is polymerised in the presence of a polymerization catalyst as stated above and a chain transfer agent such as hydrogen. The diluent is typically an inert aliphatic hydrocarbon, preferably isobutane or propane. The reaction product is then transferred, preferably to continuously operating gas phase reactor. The second component can then be formed in a gas phase reactor using preferably the same catalyst.

Such HDPEs can be commercially available. Suitable example are e.g. commercially available polyethylene pipe grades without fillers, such as natural PE100 grades. One suitable example is commercially available from Borealis AG under the tradename HE3493 LS-H.

In case of a commercially available HDPE the above stated properties can be measured using a common measurement method or verified by the technical documentation provided by the supplier.

Such LLDPEs can be commercially available. Suitable example are e.g. commercially available polyethylene film grades. One suitable example is commercially available from Borealis AG under the tradename FB2310.

In case of a commercially available LLDPE the above stated properties can be measured using a common measurement method or verified by the technical documentation provided by the supplier.

In the second embodiment the polypropylene composition preferably further comprises from 500 to 5000 ppm, preferably from 750 to 4000 ppm, most preferably from 1000 to 3000 ppm alpha-nucleating agent and/or from 1000 to 7500 ppm, preferably from 1500 to 6000 ppm, most preferably from 2000 to 5000 ppm acid scavenger, based on the total weight of the polypropylene composition.

Suitable acid scavengers and alpha-nucleating agents are discussed above.

In a third embodiment the copolymer of ethylene (B) is a low density polyethylene (LDPE), more preferably a low density polyethylene (LDPE) homopolymer.

The LDPE preferably has a density of from 915 to 930 kg/m³, more preferably from 917 to 927 kg/m³, most preferably from 920 to 925 kg/m³.

Further, the LDPE preferably has a melt flow rate MFR₅ of from 1.0 to 5.0 g/10 min, more preferably from 1.5 to 4.0 g/10 min, most preferably from 2.0 to 3.5 g/10 min.

Still further, the LDPE preferably has a melt flow rate MFR₂ (190° C., 2.16 kg) of from 0.1 to 2.0 g/10 min, preferably from 0.3 to 1.7 g/10 min, most preferably from 0.5 to 1.5 g/10 min.

Furthermore, the LDPE preferably has a melting temperature Tm of from 95 to 125° C., preferably from 100 to 120° C., mot preferably from 105 to 115° C.

The LDPE is a polyethylene produced in a high pressure polymerization process. Typically the polymerization of ethylene and optional further comonomer(s) in the high pressure polymerization process is carried out in the presence of an initiator(s). Such processes are disclosed in, among others, WO-A-96/016119, EP-A-1,777,238, EP-A-1,167,396, DE-A-10 351 262 and WO-A-2007/134671.

Such LDPEs can be commercially available.

In case of a commercially available LDPE the above stated properties can be measured using a common measurement method or verified by the technical documentation provided by the supplier.

### Article

In a further aspect the present invention further relates to an article comprising the polypropylene composition as defined above or below.

The article is preferably a cable comprising an insulation layer comprising the polypropylene composition as described above or below.

The cable usually comprises of at least one conductor and at least one insulation layer comprising the polypropylene composition as described above or below.

The term “conductor” means herein above and below that the conductor comprises one or more wires. The wire can be for any use and be e.g. optical, telecommunication or electrical wire. Moreover, the cable may comprise one or more such conductors. Preferably the conductor is an electrical conductor and comprises one or more metal wires. The cable is preferably a power cable. A power cable is defined to be a cable transferring energy operating at any voltage, typically operating at voltages higher than 1 kV. The voltage applied to the power cable can be alternating (AC), direct (DC), or transient (impulse). The polypropylene composition of the invention is very suitable for power cables, especially for power cables operating at voltages 6 kV to 36 kV (medium voltage (MV) cables) and at voltages higher than 36 kV, known as high voltage (HV) cables and extra high voltage (EHV) cables, which EHV cables operate, as well known, at very high voltages. The terms have well known meanings and indicate the operating level of such cables.

For low voltage applications the cable system typically either consists of one conductor and one insulation layer comprising the polypropylene composition as described above or below, or of one conductor, one insulation layer comprising the polypropylene composition as described above or below and an additional jacketing layer, or of one conductor, one semiconductive layer and one insulation layer comprising the polypropylene composition as described above or below.

For medium and high voltage applications the cable system typically consists of one conductor, one inner semiconductive layer, one insulation layer comprising the polypropylene composition as described above or below and one outer semiconductive layer, optionally covered by an additionally jacketing layer.

The semiconductive layers mentioned preferably comprise, more preferably consist of a thermoplastic polyolefin composition, preferably a polyethylene composition or a polypropylene composition, containing a sufficient amount of electrically conducting solid fillers preferably carbon black. It is preferred that the thermoplastic polyolefin composition of the semiconductive layer(s) is a polypropylene composition, more preferably a polypropylene composition comprising a heterophasic propylene copolymer as polymeric component. It is especially preferred that the thermoplastic polyolefin composition of the at least one semiconductive layer, preferably both semiconductive layers of the cable, comprise the same copolymer of propylene as the insulation layer, i.e. the copolymer of propylene as described above or below.

The cable comprising an insulation layer comprising the polypropylene composition according to the invention as described above shows good AC electrical breakdown strength in form of Weibull alpha-value and Weibull beta-value.

The cable preferably has a Weibull alpha-value of from 35.0 to 65.0 kV/mm, preferably from 37.5 to 65.0 kV/mm and most preferably from 40.0 to 65.0 kV/mm, when measured on a 10 kV cable.

Still further, the cable preferably has a Weibull beta-value of from 5.0 to 250.0, preferably from 5.5 to 250.0, most preferably from 6.0 to 250.0, when measured on a 10 kV cable.

Thus, the insulation layer comprising the polypropylene composition according to the invention can be used for medium and high voltage cables.

In yet another aspect the present invention relates to the use of the polypropylene composition as described above or below as cable insulation for medium and high voltage cables.

Said medium and high voltage cables preferably meet all properties requirements as described for the cables above and below.

### Benefits of the Invention

The polypropylene composition shows a good balance of properties regarding high flexibility, a good mechanical strength, good impact properties and high crystallization and melting temperature which allow the use as cable insulation e.g. for medium and high voltage cables at high operation temperatures. By adding the polymer of ethylene (B) to the polypropylene composition the improved impact properties can be further improved whereby the crystallization temperature can be increased at still sufficient (addition of HDPE and LLDPE) or increased (addition of LDPE) flexibility and comparable (addition of LDPE) or lower (addition of HDPE or LLDPE) melting temperature.

It has been found that even with melt flow rates as low as 0.5 to 2.5 g/10 min the inventive polypropylene can be easily compounded to prepare the insulation layer without need of increasing the melt flow rate via visbreaking.

Cables comprising an insulation layer comprising the inventive polypropylene composition surprisingly show good AC breakdown strength in form of Weibull alpha-value and Weibull beta-value. Thereby, the addition of the polymer of ethylene (B) to the polypropylene composition further improves the AC breakdown strength compared to polypropylene compositions which only include the copolymer of propylene (A) as polymeric compound.

The good AC breakdown strength in form of Weibull alpha-value and Weibull beta-value can be obtained without addition of a dielectric fluid such as e.g. described in EP 2 739 679.

### EXAMPLES

The following definitions of terms and determination methods apply for the above general description of the invention as well as to the below examples unless otherwise defined.

### 1. Measurement Methods

### a) Melt Flow Rate (MFR₂)

The melt flow rate is the quantity of polymer in grams which the test apparatus standardized to ISO 1133 extrudes within 10 minutes at a certain temperature under a certain load.

The melt flow rate MFR₂ of propylene based polymers and the polypropylene composition is measured at 230° C. with a load of 2.16 kg according to ISO 1133.

The melt flow rate MFR₂ of the ethylene based polymers and polyethylene compositions is measured at 190° C. with a load of 2.16 kg according to ISO 1133.

The melt flow rate MFR₅ of the ethylene based polymers and polyethylene compositions is measured at 190° C. with a load of 5 kg according to ISO 1133.

The melt flow rate MFR₂₁ of the ethylene based polymers and polyethylene compositions is measured at 190° C. with a load of 21.6 kg according to ISO 1133.

### b) Density

The density is measured according to ISO 1183-1:2004 Method A on compression moulded specimen prepared according to EN ISO 1872-2 (February 2007) and is given in kg/m³.

### c) Comonomer Content

### Method I (HECOs)

### Comonomer Content Quantification of Poly(Propylene-Co-Ethylene) Copolymers

Quantitative ¹³C{¹H}NMR spectra were recorded in the solution-state using a Bruker Avance NEO 400 NMR spectrometer operating at 400.15 and 100.62 MHz for ¹H and ¹³C respectively. All spectra were recorded using a ¹³C optimised 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 60 mM solution of relaxation agent in solvent {8} and with approximately 3 mg BHT (2,6-di-tert-butyl-4-methylphenol CAS 128-37-0). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {3, 4}. A total of 6144 (6k) transients were acquired per spectra.

Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed {7}.

The comonomer fraction was quantified using the method of Wang et. al. {6} through integration of multiple signals across the whole spectral region in the ¹³C{¹H} spectra. This method was chosen for its robust nature and ability to account for the presence of regiodefects when needed. Integral regions were slightly adjusted to increase applicability across the whole range of encountered comonomer contents. For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S αβ + S αγ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et al. {6}. Equations used for absolute propylene content were not modified.

The mole percent comonomer incorporation was calculated from the mole fraction: E [mol %]=100*fE

$$E [ mol \% ] = 100 * fE$$

The weight percent comonomer incorporation was calculated from the mole fraction:

$$e [ wt \% ] = 100 * ( fE * 28.06 ) / ( ( fE * 28.06 ) + ( ( 1 - fE ) * 42.08 ) )$$

### BIBLIOGRAPHIC REFERENCES

1) Busico, V., Cipullo, R., Prog. Polym. Sci. 26 (2001) 443.
2) Busico, V., Cipullo, R., Monaco, G., Vacatello, M., Segre, A. L., Macromolecules 30 (1997) 6251.
3) Zhou, Z., Kuemmerle, R., Qiu, X., Redwine, D., Cong, R., Taha, A., Baugh, D. Winniford, B., J. Mag. Reson. 187 (2007) 225.
4) Busico, V., Carbonniere, P., Cipullo, R., Pellecchia, R., Severn, J., Talarico, G., Macromol. Rapid Commun. 2007, 28, 1128.
5) Resconi, L., Cavallo, L., Fait, A., Piemontesi, F., Chem. Rev. 2000, 100, 1253.
6) Wang, W-J., Zhu, S., Macromolecules 33 (2000), 1157.
7) Cheng, H. N., Macromolecules 17 (1984), 1950.
8) Singh, G., Kothari, A., Gupta, V., Polymer Testing 28 5 (2009), 475.
9) Kakugo, M., Naito, Y., Mizunuma, K., Miyatake, T. Macromolecules 15 (1982) 1150.
10) Randall, J. Macromol. Sci., Rev. Macromol. Chem. Phys. 1989, C29, 201.
11) Resconi, L., Cavallo, L., Fait, A., Piemontesi, F., Chem. Rev. 2000, 100, 1253.

### Method II (Composites)

### Quantification of the Total C2, C3 and C4 Content in Composites

Quantitative ¹³C{¹H}NMR spectra were recorded in the solution-state using a Bruker Avance Neo 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz.

Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6k) transients were acquired per spectra.

Quantitative ¹³C{¹H}NMR spectra were processed, integrated and relevant quantitative properties determined from the integrals. All chemical shifts were indirectly referenced to the central methylene group of the ethylene block (EEE) at 30.00 ppm using the chemical shift of the solvent.

Characteristic signals corresponding to various incorporations of ethylene and butene, as described in Cheng, H. N., Macromolecules 1984, 17, and A. J. Brandolini, D. D. Hills, “NMR spectra of polymers and polymer additives”, Marcel Deker Inc., 2000, were observed.

The comonomer fraction was quantified using a compareable triad approach as reported by L. Abis, Mackromol. Chem. 187, 1877-1886 (1986) for ZN C2C3 copolymers but with introduction of C4 quantification. For the quantification of the C4 content the branching signal at 39.8 ppm was choosen and the signal at 22.9 ppm selected to compensate the C2C4 chain if saturated endgroups observable. In terms of C2 content only the total amount resulting from both C2C3, C2C4 and additional blend components containing C2 can be quantified by use of the methylene sequence at 30.0 ppm.

assignment table ¹³C NMR spectra

| chemical shift [ppm] | assignment | label |
|---|---|---|
| 33.4 | EPE (CH) | A |
| 31.3-30.7 | PPE (CH) + Sgg + BHT | B |
| 30.4 | Sgd | C |
| 29.9 | Sdd | D |
| 29.6-28.2 | PPP (CH) | E |
| 27.8-26.5 | Sbd (2B2 not included) | F |
| 25.2-24.3 | Sbb | G |
| 39.8 | EBE | H |
| 152 | quart C BHT | BHT |
| 22.9 | 2s | J |

triad equations

| triad sequence | signal / equation |
|---|---|
| PEP | G |
| PEE | F |
| EEE | (D + (J*3))/2 + C/4 + H |
| PPP | E |
| PPE | (B − 6* BHT) − ((F − C) / 2) |
| EPE | A |
| EBE | H |

After quantification of the mol fraction and normalisation, the amounts of C2, C3 and C4 can be calculated by summing the E, P and B centered triads:

$$sums of triad = PEP + PEE + EE + PPP + PPE + EPE + EBE$$

$$\begin{matrix}fmol PEP = PEP / sum of triads & mol \% PEP = fmol PEP * 100 \\ fmol PEE = PEE / sum of triads & mol \% PEE = fmol PEE * 100 \\ fmol EEE = EEE / sum of triads & mol \% EEE = fmol EEE * 100 \\ fmol PPP = PPP / sum of triads & mol \% PPP = fmol PPP * 100 \\ fmol PPE = PPE / sum of triads & mol \% PPE = fmol PPE * 100 \\ fmol EPE = EPE / sum of triads & mol \% EPE = fmol EPE * 100 \\ fmol EBE = EBE / sum of triads & mol \% EBE = fmol EBE * 100\end{matrix}$$

$$C 2 [ mol \% ] = mol \% PEP + mol \% PEE + mol \% EEE$$

$$C 3 [ mol \% ] = mol \% PPP + mol \% PPE + mol \% EPE$$

$$C 4 [ mol \% ] = mol \% EBE$$

The weight percent comonomer is calculated from the mole percent in the usual manner:

$$wt \% C 2 total = 100 * ( C 2 [ mol \% ] * 28.06 ) / ( ( C 2 [ mol \% ] * 28.06 ) + ( C 3 [ mol \% ] * 42.08 ) + ( C 4 [ mol \% ] * 56.11 ) )$$

$$wt \% C 3 total = 100 * ( C 3 [ mol \% ] * 42.08 ) / ( ( C 2 [ mol \% ] * 28.06 ) + ( C 3 [ mol \% ] * 42.08 ) + ( C 4 [ mol \% ] * 56.11 ) )$$

$$wt \% C 4 total = 100 * ( C 4 [ mol \% ] * 56.11 ) / ( ( C 2 [ mol \% ] * 28.06 ) + ( C 3 [ mol \% ] * 42.08 ) + ( C 4 [ mol \% ] * 56.11 ) )$$

### d) Differential Scanning Calorimetry (DSC) Analysis, Melting Temperature (Tm) and Crystallization Temperature (Tc):

measured with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30° C. to +225° C.

Crystallization temperature and heat of crystallization (Hc) are determined from the cooling step, while melting temperature and heat of fusion (Hf) are determined from the second heating step.

When a sample shows two or more melting temperatures and/or crystallization temperatures only the main melting temperature (at the highest Hc) and main crystallization temperature (at the highest Hf) are displayed in the accordant table.

The difference of melting temperature and crystallization temperature (Tm-Tc) is given for the main melting temperature and the main crystallization temperature.

### e) Xylene Cold Solubles (XCS) Content

The quantity of xylene soluble matter in polypropylene is determined according to the ISO16152 (first edition; 2005-07-01).

A weighed amount of a sample is dissolved in hot xylene under reflux conditions at 135° C. The solution is then cooled down under controlled conditions and maintained at 25° C. for 30 minutes to ensure controlled crystallization of the insoluble fraction. This insoluble fraction is then separated by filtration. Xylene is evaporated from the filtrate leaving the soluble fraction as a residue. The percentage of this fraction is determined gravimetrically.

$$\% XS = \frac{{m}_{1} \times {v}_{0}}{{m}_{0} \times {v}_{1}} \times 100$$

where
m₀ is the mass of the sample test portion weighed, in grams
m₁ is the mass of residue, in grams
v₀ is the original volume of solvent taken
v₁ is the volume of the aliquot taken for determination.

### f) Intrinsic Viscosity (IV)

The reduced viscosity (also known as viscosity number), η_{red}, and intrinsic viscosity, IV, are determined according to ISO 1628-3: “Determination of the viscosity of polymers in dilute solution using capillary viscometers”.

Relative viscosities of a diluted polymer solution with concentration of 1 mg/ml and of the pure solvent (decahydronaphthalene stabilized with 200 ppm 2,6-bis(1,1-dimethylethyl)-4-methylphenol) are determined in an automated capillary viscometer (Lauda PVS1) equipped with 4 Ubbelohde capillaries placed in a thermostatic bath filled with silicone oil. The bath temperature is maintained at 135° C. The sample is dissolved with constant stirring until complete dissolution is achieved (typically within 90 min).

The efflux time of the polymer solution as well as of the pure solvent are measured several times until three consecutive readings do not differ for more than 0.2s (standard deviation).

The relative viscosity of the polymer solution is determined as the ratio of averaged efflux times in seconds obtained for both, polymer solution and solvent:

$${η}_{rel} = \frac{{t}_{solution} - {t}_{solvent}}{{t}_{solvent}} [ dimensionless ]$$

Reduced viscosity (η_{red}) is calculated using the equation:

$${η}_{red} = \frac{{t}_{solution} - {t}_{solvent}}{{t}_{solvent} * C} [ dl / g ]$$

where C is the polymer solution concentration at 135° C.:

$$C = \frac{m}{V γ} ,$$

and m is the polymer mass, V is the solvent volume, and γ is the ratio of solvent densities at 20° C. and 135° C. (γ=ρ₂₀/ρ₁₃₅=1.107).

The calculation of intrinsic viscosity IV is performed by using the Schulz-Blaschke equation from the single concentration measurement:

$$IV = \frac{{η}_{red}}{1 + K + C + {η}_{red}}$$

where K is a coefficient depending on the polymer structure and concentration. For calculation of the approximate value for IV, K=0.27.

### g) Molecular Weight Averages, Polydispersity (Mn, Mw, Mz, MWD) by GPC-Analysis (GPC)

For the GPC analysis the column set was calibrated using universal calibration (according to ISO 16014-2:2003) with 19 narrow MWD polystyrene (PS) standards in the range of 0.5 kg/mol to 11 500 kg/mol. The PS standards were dissolved at 160° C. for 15 min or alternatively at room temperatures at a concentration of 0.2 mg/ml for molecular weight higher and equal 899 kg/mol and at a concentration of 1 mg/ml for molecular weight below 899 kg/mol. The conversion of the polystyrene peak molecular weight to polyethylene molecular weights is accomplished by using the Mark Houwink equation and the following Mark Houwink constants:

$${K}_{PS} = 19 \times {10}^{- 3} ml / g , {α}_{PS} = 0.655$$

$${K}_{PE} = 39 \times {10}^{- 3} ml / g , {α}_{PE} = 0.725$$

A third order polynomial fit was used to fit the calibration data.

Molecular weight averages (Mz, Mw and Mn), Molecular weight distribution (MWD) and its broadness, described by polydispersity index, PD=Mw/Mn (wherein Mn is the number average molecular weight and Mw is the weight average molecular weight) were determined using the following formulas:

$${M}_{n} = \frac{{\sum }_{i = 1}^{N} {A}_{i}}{\sum ( {A}_{i} / {M}_{i} )} \qquad ( 1 )$$

$${M}_{w} = \frac{{\sum }_{i = 1}^{N} ( {A}_{i} x {M}_{i} )}{\sum {A}_{i}} \qquad ( 2 )$$

$${M}_{z} = \frac{{\sum }_{i = 1}^{N} ( {A}_{i} x {M}_{i}^{2} )}{\sum ( {A}_{i} / {M}_{i} )} \qquad ( 3 )$$

### h) Glass Transition Temperature Tg

Glass transition temperature Tg was determined by dynamic mechanical analysis (DMTA) according to ISO 6721-7. The measurements were done in torsion mode on compression moulded samples (40×10×1 mm3) between −100° C. and +150° C. with a heating rate of 2° C./min and a frequency of 1 Hz. Tg was determined from the curve of the loss angle (tan(δ)).

### i) Flexural Modulus

The flexural modulus was determined acc. to ISO 178 method A (3-point bending test) on 80 mm×10 mm×4 mm specimens. Following the standard, a test speed of 2 mm/min and a span length of 16 times the thickness was used. The testing temperature was 23±2° C. Injection moulding was carried out according to ISO 19069-2 using a melt temperature of 230° C. for all materials irrespective of material melt flow rate.

### j) Tensile Properties

Tensile properties are measured at 23° C. according to ISO 527-1 with a specimen Type 1A, at cross head speed 1 mm/min. Test specimens were notched out of the sheets as per Type 1A dimensions and compression molded sheets of thickness 4.0 mm was prepared according to ISO 1872-2 at molding temperature of 180° C. Material was pre-heated by applying light contact pressure for 5 min. Then full pressure was applied for 5 min, after which material was cooled with a cooling rate of 15° C./min and demolding temperature was 40° C.

### k) Charpy Notched Impact Strength

The Charpy notched impact strength was determined acc. to ISO 179-1/leA on notched 80 mm×10 mm×4 mm specimens (specimens were prepared according to ISO 179-1/1 eA). Testing temperatures were 23±2° C. or −20±2° C. Injection moulding was carried out acc. to ISO 19069-2 using a melt temperature of 230° C. for all materials irrespective of material melt flow rate.

### l) AC Electric Breakdown Strength (ACBD)

The AC breakdown tests were performed in agreement with CENELEC HD 605 5.4.15.3.4 for 6/10 kV cables. The cable was thus cut into six test samples of 10 meter active length (terminations in addition). The samples were tested to breakdown with a 50 Hz AC step test at ambient temperature, according to the following procedure:
Start at 18 kV for 5 minutes
Voltage increasing in step of 6 kV every 5 minutes until breakdown occurs

The calculation of the Weibull parameters of the data set of six breakdown values (conductor stress, i.e. the electric field at the inner semiconductive layer) follows the least squares regression procedure as described in IEC 62539 (2007). The Weibull alpha parameter in this document refers to the scale parameter of the Weibull distribution, i.e. the voltage for which the failure probability is 0.632. The Weibull beta value refers to the shape parameter.

### 2. Propylene Copolymer Composition

The following resins were used for the preparation of the propylene copolymer compositions of the examples:

### a) Polymerization of the Heterophasic Propylene Copolymer Powder A1

### Catalyst

The catalyst used in the polymerization process for the heterophasic propylene copolymer powder A1 was a Ziegler-Natta catalyst, which is described in patent publications EP491566, EP591224 and EP586390. As co-catalyst triethyl-aluminium (TEAL) and as donor dicyclo pentyl dimethoxy silane (D-donor) was used.
Polymerization of the heterophasic propylene copolymer powder Heterophasic propylene copolymer powder A1 was produced in a Borstar™ plant in the presence of the above described polymerization catalyst using one liquid-phase loop reactor and two gas phase reactors connected in series under conditions as shown in Table 1. The first reaction zone was a loop reactor and the second and third reaction zones were gas phase reactors. The matrix phase was polymerized in the loop and first gas phase reactor and the elastomeric phase was polymerized in the second gas phase reactor. The catalyst as described above was fed into a prepolymerization reactor which precedes the first reaction zone.

TABLE 1
Polymerization conditions of the heterophasic
propylene copolymer powder:

| | | A1-powder |
|---|---|---|
| Prepolymerization | | |
| TEAL/Ti ratio | [mol/mol] | 342 |
| Donor/Ti ratio | [mol/mol] | 26.9 |
| Temperature | [° C.] | 19.9 |
| Residence time | [h] | 0.16 |
| Loop | | |
| Temperature | [° C.] | 70.0 |
| Pressure | [barg] | 55 |
| Split (Loop + Prepol) | [%] | 33.7 |
| H2/C3 ratio | [mol/kmol] | 5.5 |
| C2/C3 ratio | [mol/kmol] | 16.7 |
| MFR (230° C./2.16 kg) | [g/10 min] | 6.5 |
| C2 content (calc.) | [wt %] | 2.0 |
| GPR 1 | | |
| Temperature | [° C.] | 74.9 |
| Pressure | [barg] | 21.0 |
| Split (GPR1) | [%] | 48.2 |
| H2/C3 ratio | [mol/kmol] | 21.3 |
| C2/C3 ratio | [mol/kmol] | 53.4 |
| MFR (230° C./2.16 kg) | [g/10 min] | 1.3 |
| C2 content (calc.) | [wt %] | 6.5 |
| GPR 2 | | |
| Temperature | [° C.] | 79.99 |
| Pressure | [barg] | 16.03 |
| Split (GPR2) | [%] | 18.2 |
| C2/C3 ratio | [mol/kmol] | 401 |
| H2/C3 ratio | [mol/kmol] | 69 |
| MFR (230° C./2.16 kg) | [g/10 min] | 1.2 |
| XCS | [wt %] | 35.3 |
| C2 (content calc.) | [wt %] | 10.5 |

### b) Preparation of the Polypropylene Compositions

The heterophasic propylene copolymer powder A1 from the polymerization reaction was compounded in a twin screw extruder together with a stabilizer package to obtain the polypropylene compositions of reference example RE1.

An overview of the production of the polypropylene compositions of example RE1 is shown in Table 2.

TABLE 2
Compounding of RE1 in a twin screw extruder:

| | | RE1 |
|---|---|---|
| HECO-powder | | A1-powder |
| Visbreaking | | no |
| Stabiliser onepack 1 | [wt %] | 0.2 |
| Temp. ranges of extruder zones | [° C.] | 140-300 |
| Specific Energy Input (SEI) | kWh/kg | 0.155 |
| Polymer melt temp. at melt pump | [° C.] | 244 |

The polypropylene composition RE1 shows the properties as listed below in Table 3.

TABLE 3
Properties of polypropylene composition RE1:

| | | RE1 |
|---|---|---|
| alpha-NA | | no |
| MFR₂ | [g/10 min] | 1.2 |
| Flexural modulus | [MPa] | 335 |
| Charpy NIS (−20° C.) | [kJ/m²] | 6.3 |
| Charpy NIS (23° C.) | [kJ/m²] | 83.9 |
| Tm | [° C.] | 148.9 |
| Tc | [° C.] | 95.7 |
| Tm − Tc | [° C.] | 53.2 |
| C2 (total) | [wt %] | 12.4 |
| IV (total) | [cm³/g] | 277 |
| XCS fraction | [wt %] | 35.6 |
| C2 (XCS) | [wt %] | 26.1 |
| IV (XCS) | [cm³/g] | 251 |
| Mw (XCS) | [g/mol] | 294,500 |
| Mn (XCS) | [g/mol] | 45,650 |
| PDI (Mw/Mn) (XCS) | [—] | 6.4 |
| XCI fraction | [wt %] | 64.4 |
| C2 (XCI) | [wt %] | 4.8 |
| IV (XCI) | [cm³/g] | 286 |
| Mw (XCI) | [g/mol] | 384,500 |
| Mn (XCI) | [g/mol] | 69,500 |
| PDI (Mw/Mn) (XCI) | [—] | 5.5 |
| IV ratio (XCI/XCS) | [—] | 1.14 |
| Mw ratio (XCI/XCS) | [—] | 1.31 |

For the production of the polymer compositions of the inventive examples IE1, IE2 and IE3 and comparative example CE1 the compounded pellets of reference example RE1 were compounded in a second compounding step in a Buss 100 MDK L/D 11D co-kneader together with different additives. An overview of the production of the polypropylene compositions CE1, IE1, IE2 and IE3 are shown in Table 4. The properties of CE1, IE1, IE2 and IE3 are shown in Table 5.

TABLE 4
Compounding of CE1, IE1 and IE2 in
a Buss 100 MDK L/D 11D co-kneader:

| | | CE1 | IE1 | IE2 | IE3 |
|---|---|---|---|---|---|
| Pellets | | RE1 | RE1 | RE1 | RE1 |
| HDPE | [wt %] | — | 10 | — | — |
| LDPE | [wt %] | — | — | 10 | — |
| LLDPE | [wt %] | — | — | — | 10 |
| Millad 3988 | ppm | — | — | — | 2000 |
| Ca-stearate | ppm | — | — | — | 2300 |
| Mixer zones | [° C.] | 134-218 | 127-205 | 123-204 | 125-204 |
| temperatures | | | | | |
| Mixer RPM | | 150 | 150 | 150 | 150 |
| Specific Energy | [kWh/kg] | 0.29 | 0.28 | 0.26 | 0.26 |
| Input SEI | | | | | |

### Stabilizer Packages and Additives:

Stabiliser onepack consists of 21.8 wt % Pentaerythrityl-tetrakis(3-(3′,5′-di-tert. butyl-4-hydroxyphenyl)-propionate (CAS-No. 6683-19-8), 43.6 wt % Tris (2,4-di-t-butylphenyl) phosphite (CAS-No. 31570-04-4) and 34.6 wt % Calcium stearate (CAS-No. 1592-23-0), all commercially available from a variety of companies.
HDPE is a Ziegler-Natta catalyzed bimodal high density poly(ethylene-co-1-hexene) copolymer having a density of 951 kg/m³, a melt flow rate MFR₂ (190° C., 2.16 kg) of 0.05 g/10 min, a melt flow rate MFR₅ (190° C., 5 kg) of 0.3 g/10 min, a melting temperature Tm of 132.5° C., a crystallization temperature of 113.6° C., a tensile modulus (1 mm/min) of 1000 MPa, a tensile strain at break (50 mm/min) of more than 600% and a tensile stress at yield (50 mm/min) of 25 MPa, and is commercially available as HE3493-LS from Borealis AG.
LDPE is a low density ethylene homopolymer produced in a commercial high pressure tubular reactor at a pressure 2500-3000 bar and max temperature 250-300° C. using conventional peroxide initiatior. Ethylene monomer was added to the reactor system in a conventional manner. CTA was used to regulate MFR as well known for a skilled person. LDPE has a density of 922.5 kg/m³ a melt flow rate MFR₂ (190° C., 2.16 kg) of 0.75 g/10 min and a melt flow rate MFR₅ (190° C., 5 kg) of 2.9 g/10 min, and a melting temperature Tm of 109.9° C.
LLDPE is a Ziegler-Natta catalyzed bimodal linear low density poly(ethylene-co-1-butene) copolymer having a density of 931 kg/m³, a melt flow rate MFR₂ (190° C., 2.16 kg) of 0.2 g/10 min, a melt flow rate MFR₅ (190° C., 5 kg) of 0.9 g/10 min, a melt flow rate 12FR21 (190° C., 21.6 kg) of20 g/10 mi, a 1-butene content of4.9 wtm and a melting temperature Tm of 127° C., and is commercially available as FB2310 from Borealis AG.
Millad 3988 is a sorbitol-based particulate alpha-nucleating agent comprising 1,3:2,4-bis(3,4-dimethylbenzylidene)sorbitol (CAS-No. 135861-56-2), commercially available from Milliken Chemical
The additional calcium stearate (CAS-No. 1592-23-0) added to IE3 is commercially available from a variety of companies.

TABLE 5
Properties of the compounded compositions of CE1, IE1, IE2, IE3

| | | CE1 | IE1 | IE2 | IE3 |
|---|---|---|---|---|---|
| MFR₂ | [g/10 min] | 1.4 | 1.2 | 1.2 | 1.2 |
| Flex. modulus | [MPa] | 332 | 379 | 307 | 379 |
| Charpy NIS 23° C. | [kg/m³] | 79.9 | 87.6 | 84.2 | 83.6 |
| Charpy NIS −20° C. | [kg/m²] | 4.5 | 6.3 | 6.4 | 6.5 |
| Tm | [° C.] | 149.9 | 127.3 | 150.4 | 127.7 |
| Tc | [° C.] | 97.4 | 108.7 | 101.4 | 119.4 |
| Tm − Tc | [° C.] | 52.5 | 18.6 | 49.0 | 8.3 |
| Tg (EP) | [° C.] | −47.9 | −45.9 | −45.6 | −46.2 |
| Tg (Matrix) | [° C.] | −7.5 | −7.1 | −7.7 | −6.6 |
| C2 (total) | [wt %] | 12.6 | 20.5 | 20.2 | 20.3 |
| C4 (total) | [wt %] | n.a. | n.a. | n.a. | 0.6 |
| C6 (total) | [wt %] | n.a. | n.p. | n.a. | n.a. |
| XCS fraction | [wt %] | 36.9 | 31.2 | 32.4 | 32.7 |
| C2 (XCS) | [wt %] | 25.4 | 26.2 | 25.9 | 28.8 |
| C4 (XCS) | [wt %] | n.a. | n.a. | n.a. | 0.8 |
| C6 (XCS) | [wt %] | n.a. | n.p. | n.a. | n.a. |
| IV (XCS) | [cm³/g] | 260 | 259 | 256 | 244 |
| Mw (XCS) | [g/mol] | 283,000 | 274,000 | 280,000 | 268,500 |
| Mn (XCS) | [g/mol] | 39,400 | 40,750 | 45,450 | 39,850 |
| Mw/Mn (XCS) | [—] | 7.2 | 6.7 | 6.2 | 6.7 |
| XCI fraction | [wt %] | 63.1 | 68.8 | 67.6 | 67.3 |
| C2 (XCI) | [wt %] | 5.7 | 16.2 | 17.3 | 15.3 |
| C4 (XCI) | [wt %] | n.a. | n.a. | n.a. | 0.3 |
| C6 (XCI) | [wt %] | n.a. | n.p. | n.a. | n.a. |
| IV (XCI) | [cm³/g] | 245 | 288 | 256 | 272 |
| Mw (XCI) | [g/mol] | 296,000 | 352,500 | 310,500 | 337,500 |
| Mn (XCI) | [g/mol] | 56,100 | 46,650 | 58,750 | 53,650 |
| Mw/Mn (XCI) | [—] | 5.3 | 7.7 | 5.3 | 6.3 |
| IV(XCI)/IV(XCS) | [—] | 0.94 | 1.11 | 1.00 | 1.11 |
| Mw(XCI)/Mw(XCS) | [—] | 1.05 | 1.29 | 1.11 | 1.26 |
| ω_{COP} | [1/s] | 14.0 | 12.3 | 12.3 | 13.2 |
| SHI 1/100 | [—] | 10.8 | 11.1 | 12.5 | 10.7 |
| PI | [1/s] | 2.7 | 2.7 | 2.9 | 2.6 |

n.a. not applicable
n.p. not possible;
e.g. below detection limit

It can be seen that the inventive compositions IEl to IE3 show improved impact properties together with an increased crystallization temperature at still sufficient (IE1 and IE3) or increased (IE2) flexibility and comparable (IE2) or lower (IE1 and IE3) melting temperature compared to the comparative composition CE1.

### 3. Production of 10 kV Cables

10 kV test cables were produced on a Maillefer pilot cable line of catenary continuous vulcanizing (CCV) type.

The conductors of the cable cores had a cross section being 50 mm² of stranded aluminium and had a cross section of 50 mm². The inner semiconductive layer was produced from semiconductive composition SC2 as described below and had a thickness of 1.0 mm. The insulation layer was produced from the above described compositions CE1, IE1, IE2 and IE3, and had a thickness of 3.4 mm. The outer semiconductive layer was produced from semiconductive compositions SC1 as described below and had a thickness of 1.0 mm.

The cables, i.e. cable cores, were produced by extrusion via a triple head. The insulation extruder had size 100 mm, the extruder for conductor screen (inner semiconductive layer) 45 mm, and the extruder for insulation screen (outer semiconductive layer) 60 mm. The line speed was 6.0 m/min.

The vulcanisation tube had a total length of 52.5 meter consisting of a curing section followed by a cooling section. The curing section was filled with N₂ at 10 bar but not heated. The 33-meter-long cooling section was filled with 20-25° C. water.

The pilot cables were then subjected to AC breakdown testing.

Semiconductive layer 1 (SC1) was prepared from ready-to-use semiconductive composition Borlink LE7710, which is a non-crosslinkable polyethylene based composition comprising carbon black, commercially available from Borealis AG.

Semiconductive layer 2 (SC2) was prepared from 66.5 wt % of the polypropylene based composition of RE1 with 33.0 wt % of carbon black Printex Alpha, commercially available from Orion Engineered Carbons GmbH, and 0.5 wt % maleic anhydride functionalized polypropylene Exxelor P01020, commercially available from Exxon Mobil.

Table 6 shows the electric properties of the 10 kV cables of examples C1-C4 in which the inventive insulation layers IE1, IE2 and IE3 are compared to reference insulation layer CE1.

TABLE 7
Electric properties of 10 kV cables of C1-C3

| | C1 | C2 | C3 | C4 |
|---|---|---|---|---|
| Insulation layer | CE1 | IE1 | IE2 | IE3 |
| Inner semiconductive layer | SC2 | SC2 | SC2 | SC2 |
| Outer semiconductive layer | SC1 | SC1 | SC1 | SC1 |
| Weibull-alpha (scale) [kV/mm] | 45.6 | 42.5 | 48.7 | 51.2 |
| Weibull-beta (shape) | 6.4 | 12.0 | 7.3 | 7.6 |

It can be seen that cables C3 and C2 comprising the inventive insulation layer IE2 and IE3 both show an increased Weibull-alpha value and increased Weibull-beta value compared to the cable comprising the reference insulation layer CE1. Cable C2 comprising the inventive insulation layer IE1 shows an increased Weibull-beta value compared to the cable C1 comprising reference insulation layer CE1.

1: A polypropylene composition comprising:
(A) from 80.0 to 99.0 wt. %, based on the total weight of the polypropylene composition, of a copolymer of propylene and comonomer units selected from ethylene and alpha-olefins having from 4 to 12 carbon atoms having;
a total amount of comonomer units of from 10.0 to 16.0 wt % based on the total amount of monomer units of the copolymer of propylene (A), determined by quantitative ¹³C{¹H}NMR measurement;
a melt flow rate MFR₂ of from 0.5 to 2.5 g/10 min, determined according to ISO 1133 at 230° C. and 2.16 kg;
a xylene cold soluble (XCS) fraction in a total amount of from 25.0 to 50.0 wt %, based on the total weight amount of the copolymer of propylene (A) and determined according to ISO16152; and
(B) from 1.0 to 20.0 wt. %, based on the total weight of the polypropylene composition, of an ethylene polymer having
a density of from 915 to 960 kg/m³, determined according to ISO 1183; and
a melt flow rate MFR₅ of from 0.05 to 5.0 g/10 min, determined according to ISO 1133 at 190° C. and 5 kg.

2: The polypropylene composition according to claim 1, wherein the copolymer of propylene (A) is a heterophasic copolymer of propylene which comprises a matrix phase and an elastomeric phase dispersed in said matrix phase, which comprises two glass transition temperatures attributed to the matrix phase and the elastomeric phase, wherein the glass transition temperature attributed to the matrix phase Tg (matrix) is in the range of from −1.0 to −15.0° C. and/or the glass transition temperature attributed to the elastomeric phase Tg (EP) is in the range of from −40.0 to −55.0° C., wherein Tg (matrix) and Tg (EP) are determined by dynamic mechanical analysis.

3: The polypropylene composition according to claim 1, wherein xylene cold soluble (XCS) fraction of the copolymer of propylene (A) has an amount of comonomer units of ethylene, of from 23.0 to 35.0 wt %, based on the total amount of monomer units in the xylene cold soluble (XCS) fraction and determined by quantitative ¹³C{¹H}NMR measurement and/or an intrinsic viscosity of from 150 to 350 cm³/g, measured in decalin according to ISO 1628-3, and/or
wherein the copolymer of propylene (A) has a fraction insoluble in cold xylene (XCI) in a total amount of from 50.0 to 75.0 wt %, based on the total weight amount of the copolymer of propylene (A) and determined according to ISO16152, and wherein the fraction insoluble in cold xylene (XCI) has an amount of comonomer units, based on the total amount of monomer units in the fraction insoluble in cold xylene (XCI) and determined by quantitative ¹³C{¹H}NMR measurement and/or an intrinsic viscosity of from 185 to 350 cm³/g, measured in decalin according to ISO 1628-3.

4: The polypropylene composition according to claim 1, wherein the copolymer of propylene (A) has one or more of the following properties:
a flexural modulus of from 130 MPa to 380 MPa, determined according to ISO 178 method A; and/or
a Charpy notched impact strength at 23° C. of from 40 to 110 kJ/m², determined according to to ISO 179-1/1eA; and/or
a Charpy notched impact strength at −20° C. of from 5.0 to 10.0 kJ/m², determined according to to ISO 179-1/1eA.

5: The polypropylene composition according to claim 1, wherein the ethylene polymer (B) is a high density copolymer of ethylene and comonomer units selected from alpha-olefins having from 4 to 12 carbon atoms (HDPE), a linear low density copolymer of ethylene and comonomer units selected from alpha-olefins having from 4 to 12 carbon atoms (LLDPE) or a low density polyethylene (LDPE).

6: The polypropylene composition according to claim 1, wherein the ethylene polymer (B) is a high density copolymer of ethylene and comonomer units selected from alpha-olefins having from 4 to 12 carbon atoms (HDPE), having one or more, of the following properties:
a density of from 940 to 960 kg/m³, determined according to ISO1183; and/or
a melt flow rate MFR₅ of from 0.05 to 1.0 g/10 min, determined according to ISO 1133 at 190° C. and 5 kg; and/or
a melt flow rate MFR₂ of from 0.001 to 0.5 g/10 min, determined according to ISO 1133 at 190° C. and 2.16 kg; and/or
a melting temperature Tm of from 125 to 140° C., determined by differential scanning calorimetry; and/or
a crystallization temperature Tc of from 100 to 125° C., determined by differential scanning calorimetry; and/or
a tensile modulus of from 750 to 1250 MPa, determined according to ISO 527-1.

7: The polypropylene composition according to claim 1, wherein the ethylene polymer (B) is a linear low density copolymer of ethylene and comonomer units selected from alpha-olefins having from 4 to 12 carbon atoms (LLDPE), a high density copolymer of ethylene and 1-butene or a high density copolymer of ethylene and 1-hexene, having one or more, of the following properties:
a density of from 920 to below 940 kg/m³, determined according to ISO1183; and/or
a comonomer content of from 1.0 to 5.0 mol %; and/or
a melt flow rate MFR₅ of from 0.1 to 2.5 g/10 min, determined according to ISO 1133 at 190° C. and 5 kg; and/or
a melt flow rate MFR₂ of from 0.01 to 1.0 g/10 min, determined according to ISO 1133 at 190° C. and 2.16 kg; and/or
a melt flow rate MFR₂₁ of from 5 to 35 g/10 min, determined according to ISO 1133 at 190° C. and 21.6 kg; and/or
a flow rate ratio FRR_{21/5}, being the ratio of MFR₂₁ to MFR₅, of from 5 to 35; and/or
a flow rate ratio FRR_{21/2}, being the ratio of MFR₂₁ to MFR₂, of from 85 to 115; and/or
a melting temperature Tm of from 120 to 135° C., determined by differential scanning calorimetry.

8: The polypropylene composition according to claim 7, further comprising from 500 to 5000 ppm alpha-nucleating agent and/or from 1000 to 7500 ppm, based on the total weight of the polypropylene composition.

9: The polypropylene composition according to claim 1, wherein the ethylene polymer (B) is a low density polyethylene (LDPE) having one or more or all of the following properties:
a density of from 915 to 930 kg/m³, determined according to IS01183; and/or
a melt flow rate MFR₅ of from 1.0 to 5.0 g/10 min, determined according to ISO 1133 at 190° C. and 5 kg; and/or
a melt flow rate MFR₂ of from 0.1 to 2.0 g/10 min, determined according to ISO 1133 at 190° C. and 2.16 kg; and/or
a melting temperature Tm of from 95 to 125° C., determined by differential scanning calorimetry.

10: The polypropylene composition according to claim 1, having one or more or all of the following properties:
a melt flow rate MFR₂ of 0.5 to 2.5 g/10 min, determined according to ISO 1133 at 230° C. and 2.16 kg; and/or
a melting temperature Tm of from 120 to 159° C., determined by differential scanning calorimetry; and/or
a crystallization temperature Tc of from 90 to 130° C., determined by differential scanning calorimetry; and/or
a difference of the melting temperature to the crystallization temperature Tm-Tc is in the range of from 2 to 65° C.; and/or
a glass temperature attributed to the matrix phase Tg (matrix) in the range of from −1.0 to −17.5° C., determined by dynamic mechanical analysis; and/or
a glass temperature attributed to the elastomeric phase Tg (EP) of from −40.0 to −55.0° C., determined by dynamic mechanical analysis; and/or
shear thinning index SHI_{1/100} of from 5.0 to 20.0, determined by dynamic shear measurements; and/or
a polydispersity index PI of from 1.0 to 4.5 s⁻¹, determined by dynamic shear measurements; and/or
a flexural modulus of from 175 MPa to 425 MPa, determined according to ISO 178 method A; and/or
a Charpy notched impact strength at 23° C. of from 50 to 110 kJ/m², determined according to to ISO 179-1/1eA; and/or
a Charpy notched impact strength at −20° C. of from 4.5 to 25.0 kJ/m², determined according to to ISO 179-1/1eA.

11: The polypropylene composition according to claim 1, not being subjected to vis-breaking.

12: The polypropylene composition according to claim 1, being free of a dielectric fluid.

13: An article comprising the polypropylene composition according to claim 1, comprising an insulation layer comprising the polypropylene composition.

14: The article according to claim 13, being a cable comprising an insulation layer comprising the polypropylene composition and having a Weibull alpha-value of from 35.0 to 65.0 kV/mm, measured on a 10 kV cable in agreement with CENELEC HD 605 5.4.15.3.4 for 6/10 kV cables.

15: The polypropylene composition according to claim 1, wherein the polypropylene composition is present as cable insulation in medium and high voltage cables.
